(19) United States
(12) Patent Application Publication
(10) Pub. No.: US 2014/0200904 A1
(43) Pub. Date: Jul. 17, 2014

(54) PRESCRIPTION BASED SHOPPING ASSISTANCE

(71) Applicant: INTERNATIONAL BUSINESS MACHINES CORPORATION, Armonk, NY (US)

(72) Inventors: Barry A. Kritt, Raleigh, NC (US); Nader M. Nassar, Yorktown Heights, NY (US); Sarbajit K. Rakshit, Kolkata (IN)

(73) Assignee: INTERNATIONAL BUSINESS MACHINES CORPORATION, Armonk, NY (US)

(21) Appl. No.: 13/740,039

(22) Filed: Jan. 11, 2013

(51) Int. Cl. G06Q 30/06; G06Q 50/22

(52) U.S. Cl. CPC G06Q 30/0631; G06Q 50/22
USPC 705/2

(57) ABSTRACT

A method, a system and a computer program product for generating a personalized shopping recommendation includes steps and structure for for creating a shopping plan, for one or more persons, on a computing device of a user, and using corresponding prescription data advised for the one or more persons by a doctor to identifying recommended products that best fit each person's requirements.

### FIELD OF THE INVENTION

The present disclosure relates to systems and methods for conducting commercial transactions. More particularly, the present disclosure relates to a method, a system and a computer program product for providing shopping assistance to a user on a computing device.

### BACKGROUND

In the present times, for different types of diseases, doctors suggest different guidelines for a patient to follow. For example, a high cholesterol patient may be recommended not to consume fat rich food items. Similarly, a low blood pressure patient may be recommended to consume high protein added food items.

However, even when such recommendations are provided, the patient still forget to follow them. In order to make it easier for the patient to follow these recommendations and guidelines, the hospitals now make the prescription from the doctor available to the patient online However, sometimes, the patient may not be aware of an undesirable component in a product that the patient may be purchasing, thereby leading to consumption of undesirable products.

In light of the above discussion, it would be desirable to provide an efficient and an easy management system and method that enables the patient to optimize his shopping list that best fit the recommendations from the doctor.

### BRIEF SUMMARY

A benefit of the present disclosure is to provide a method for generating a personalized shopping recommendation. The method includes the step of accessing a shopping plan created on a computing device of a user, the shopping plan may include items for one or more persons, followed by accessing corresponding prescription data advised for the one or more persons by a doctor. Thereafter, based on shopping plan and the prescription data, identifying recommended products that best fit each person's requirements.

Another benefit of the present disclosure is to provide a system for generating a personalized shopping recommendation. The system includes a first accessing module that is configured to access a shopping plan, for one or more persons, created on a computing device of a user. The system also includes a second accessing module that is configured to access corresponding prescription data advised for the one or more persons by a doctor. The system also includes a processing module that is configured to identify recommended products based on the shopping plan and the prescription data.

Yet another benefit of the present disclosure is to provide a computer program product for generating a personalized shopping recommendation. The computer program product includes computer readable medium that includes a program code that can be used by a processing module to generate personalized shopping recommendation. The computer program product includes instructions for accessing a shopping plan for one or more persons created on a computing device of a user, followed by accessing corresponding prescription data advised for the one or more persons by a doctor. Thereafter, based on shopping plan and the prescription data, identifying recommended products that best fit the each person's requirements.

Other embodiments and aspects of the disclosure are described in detail herein and are considered a part of the claimed invention. For a better understanding of the disclosure with advantages and features, refer to the description and to the drawings.

### BRIEF DESCRIPTION OF THE SEVERAL VIEWS OF THE DRAWINGS

The features of the present disclosure, which are believed to be novel, are set forth with particularity in the appended claims. The disclosure may best be understood by reference to the following description, taken in conjunction with the accompanying drawings. These drawings and the associated description are provided to illustrate some embodiments of the disclosure, and not to limit the scope of the disclosure.

FIG. 1 is a schematic block diagram depicting a computing device including a shopping recommendation system, in accordance with an embodiment of the present invention; and

FIG. 2 is a flowchart depicting a method of generating shopping recommendations, in accordance with an embodiment of the present invention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present disclosure.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION

Before describing the present disclosure in detail, it should be observed that the present disclosure utilizes apparatus components and method steps related to a shopping recommendation generating methods, systems and its associated functions. Accordingly the apparatus components have been represented where appropriate by conventional symbols in the drawings, showing only specific details that are pertinent for an understanding of the present disclosure so as not to obscure the disclosure with details that will be readily apparent to those with ordinary skill in the art having the benefit of the description herein.

Also, it should be observed that the present disclosure utilizes a combination of method steps and system components related to computer-implemented method for generating shopping recommendations. Accordingly, it will be appreciated that embodiments of the disclosure described herein may include one or more conventional processors and unique stored program instructions that control the one or more processing units to implement, in conjunction with certain non-processor circuits, some, most, or all of the functions of the method of displaying information associated with one or more desired contexts. The non-processor circuits may include, but are not limited to, a radio receiver, a radio transmitter, signal drivers, clock circuits, power source circuits, and user input devices. As such, these functions may be interpreted as steps of a method to perform the display. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

While the specification concludes with the claims defining the features of the disclosure that are regarded as novel, it is believed that the disclosure will be better understood from a consideration of the following description in conjunction with the drawings, in which like reference numerals are carried forward.

As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the disclosure.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

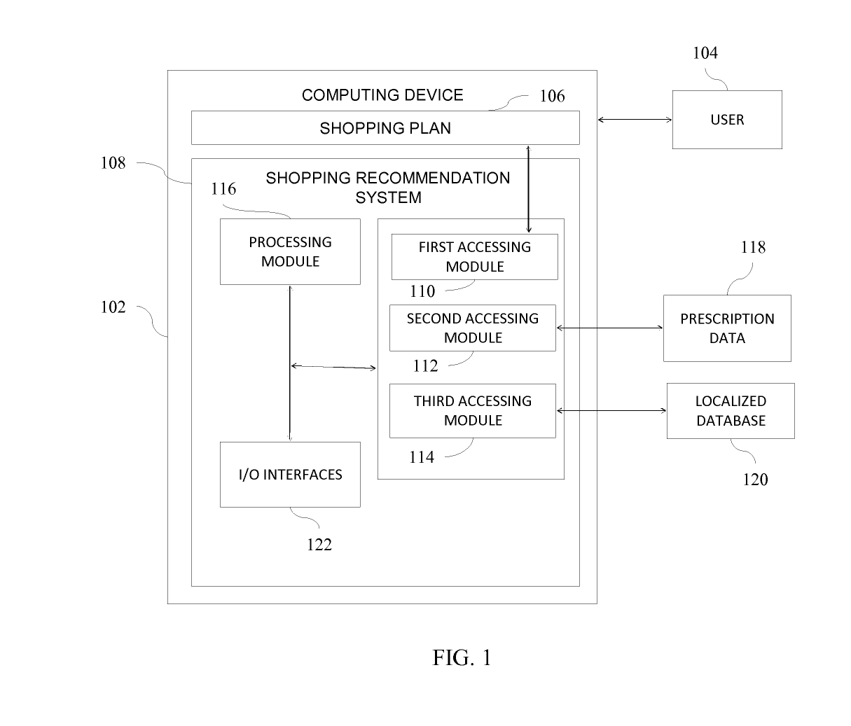

Referring now to FIG. 1, there is provided a schematic block diagram depicting a computing device 102 accessible by a user 104. The user 104 can create a shopping plan 106 including a list of food-products and non-food products on the computing device 102 that can be optimized by a system 108 for generating shopping recommendations. The system 108 may be interchangeably referred to as the shopping recommendations system 108 hereinafter in the description. In some embodiments, the shopping plan 106 created by the user 104 may include shopping plans for a person other than the user 104. In another exemplary embodiment, the user 104 may create a custom shopping plan 106 including items for more than one person.

Examples of the computing device 102 include, but are not limited to, computers, desktops, laptops, smart phones, tablet computers, wearable PCs, e-book readers, personal digital assistants (PDAs), and the like. The computing device 102 may generally include a processor communicably coupled to a memory, user output devices and user input devices. Further, shopping recommendation system 108 is designed to work on any operating system, including, but not limited to, Windows from Microsoft Corporation, iOS from Apple, Linux, Android from Google, and the like.

Moving on the shopping recommendation system 108 is shown to include a first accessing module 110, a second accessing module 112, a third accessing module 114, and a processing module 116.

In some embodiments, the first accessing module 110 may access the shopping plan 106 created by the user 104. The shopping plan 106 may be stored in a memory of the computing device 102 and the first accessing module 110 may be operably coupled with the memory to access it as required.

In some embodiments, the second accessing module 112 may access one or more databases or data stores to search for and/or retrieve prescription data 118 corresponding to the user 104 or for the person for whom the shopping plan has been created. For example, the prescription data 118 can include details of medical records related to a doctor's recommendation for the user 104 and/or prescription associated with a recommended treatment regimen. The prescription data 118 may include information related to any adverse effects the user 104 may experience on using certain food products. The prescription data 118 may include information related to certain products or ingredients that the user 104 should not be allowed to take as a result of his/her medical condition.

In an embodiment, the prescription data 118 may be provided on a hospital server. In such a case, the computing device 102 can connect with the hospital network enabling the second accessing module 112 to get access to the prescription data 118. In an exemplary scenario, if the user 104 is a high cholesterol patient, the prescription data 118 for the user 104 may include all suggested ingredients or class of ingredients that may make any product fat rich and hence should not be present in the product being bought. In another embodiment, the prescription data 118 may include an allowable upper limit to the fat content in a product.

In some embodiments, the third accessing module 114 may access one or more databases or data stores to search for and/or retrieve information regarding composition of various products listed in the shopping plan 106 that has been accessed by the first accessing module 112. This information may be available in a localized database 120. For example, the localized database may include details of all the ingredients present in a particular class of products from different manufacturers.

Moving on, the processing module 116 may be implemented in the form of one or more suitably configured microprocessors or microcontrollers. However, it should be appreciated that other implementations are also possible. In addition, the processing module 116 may be in the form of a single processor, or may be distributed across as a plurality of processing modules.

The processing module 116 described herein, may generally include circuitry for implementing communication and/or logic functions. For example, the processing module 116 may include a digital signal processor device, a microprocessor device, and various analog to digital converters, digital to analog converters, and/or other support circuits. Control and signal processing functions of the shopping recommendation system 108 may be performed by the processing module. The processing module 116 may include the functionality to interact with the first accessing module 110, the second accessing module 112, and the third accessing module 114. The processing module 116 may also include functionality to operate one or more software programs or applications. For example, the processing module 112 may be capable of operating a connectivity program, to transmit and receive content from a remote database/server.

The processing module 116 may include necessary circuitry to enable the first accessing module 110 to access the shopping plan 106. Similarly, the processing module 116 may include necessary circuitry to enable the second accessing module 112 to access the prescription data 118 and the third accessing module 114 to access the localized database 120 to retrieve information corresponding to the various products listed in the shopping plan.

Thereafter, once the first accessing module 110, the second accessing module 112 and the third accessing module 114 have retrieved required information, the processing module 116 can assess and process the shopping plan 106, the prescription data 118 and the information from the localized database 120 to optimize and generate personalized shopping recommendation for the user 104.

The processing module 116 may be further configured to identify a plurality of recommended products by checking components of products on the shopping plan 106 retrieved from the localized database against information provided in the prescription data 118. For example, in a scenario if a product listed on the shopping plan 106 is sunflower oil, then the processing module 116 will instruct the third accessing module 114 to access from the localized database 120 details of the various ingredients in sunflower oil from different manufacturers. In case, the user 104 has specified a particular manufacturer, the third accessing module 114 may be instructed to retrieve data corresponding only to the particular manufacturer. Thereafter, the processing module 116 may use information from the prescription data 118 and check that against the information retrieved by the third accessing module 114. Based on this check, the processing module 116 may recommend one or more products to the user 104.

In an embodiment, the processing module 116 may be further configured to calculate the quantity of the recommended products based on the prescription data 118. Furthermore, in some embodiments, the processing module 116 may be further configured to send a reminder for timely consumption of the recommended products. For example, in an exemplary scenario, the reminder may just be that a particular product should not be taken at same time as medicine or a particular product should not be consumed within 1 hour of taking a medicine.

In some embodiments, the processing module 116 may also be configured to display relevant advertisements on the computing device 102 based on the prescription data and the shopping plan, i.e. in addition to just providing recommended products, the user 104 may also be provided with advertisements for some relevant products.

In some embodiments, if the processing module 116 is unable to identify or recommend a suitable product, the processing module 116 may provide a warning on a problematic product on the shopping plan 106 based on the prescription data 118.

In some other embodiments, the processing module 116 may be further configured to generate an optimized route plan to locations corresponding to recommended products on the shopping plan 106. In an exemplary scenario, the processing module 116 may provide a map to a store where the recommended product may be available.

In some embodiments, the shopping plan 106 created by the user 104 may include shopping plans for a person other than the user 104. In such a scenario, the shopping recommendation system 108 may allow the user 106 to indicate the person for whom the shopping plan 106 has been created. In an exemplary embodiment, the user 104 may create a custom shopping plan 106 including items for more than one person. In such a scenario, the shopping recommendation system 108 may allow the user 106 to indicate which items correspond to which person. In such exemplary embodiments, the processing module 116 can instruct the second accessing module 112 to access prescription data for the one or more persons indicated by the user 104. Further the processing module 116 will also compare the items on the shopping plan 106 with the prescription data according to the indication of which item corresponds to which person as given by the user 106.

Moving on, in some embodiments, the computing device 102 may also include a memory (not shown), which may be operatively coupled to the processing module 116. Similarly the processing module 116 may also be operatively coupled to input/output (I/O) interfaces 122.

The memory can be used to store information retrieved by the different accessing modules. The memory may also store a number of applications or programs which include computer-executable instructions/code that can be executed by the processing module 116 to implement functions described herein. Examples of the memory can include, but are not limited to, magnetic or optical disk, flash memory, random access memory (RAM), read-only memory (ROM), or any other storage mediums that support storage of data for an arbitrary period of time (e.g., until deleted by a user).

Examples of the output (I/O) interfaces 122 may include, but are not limited to, a display (e.g., a liquid crystal display (LCD) or the like), a speaker or other audio device, which are operatively coupled to the processing module 116. Examples of input interfaces 122 may be those which allow the computing device 102 to receive data from the user 104, may include, but are not limited to, a keypad, a keyboard, touch-screen, touchpad, microphone, mouse, joystick, other pointer device, button, soft key, and/or other input device(s).

Further, while FIG. 1 illustrates various components of the computing device 102 and the shopping recommendation system 108, it will be apparent to those skilled in the art that this figure illustrates only those components that are pertinent for execution of the functions defined herein and the computing device 102 and the shopping recommendation system 108 may include additional components, without deviating from the scope of the disclosure.

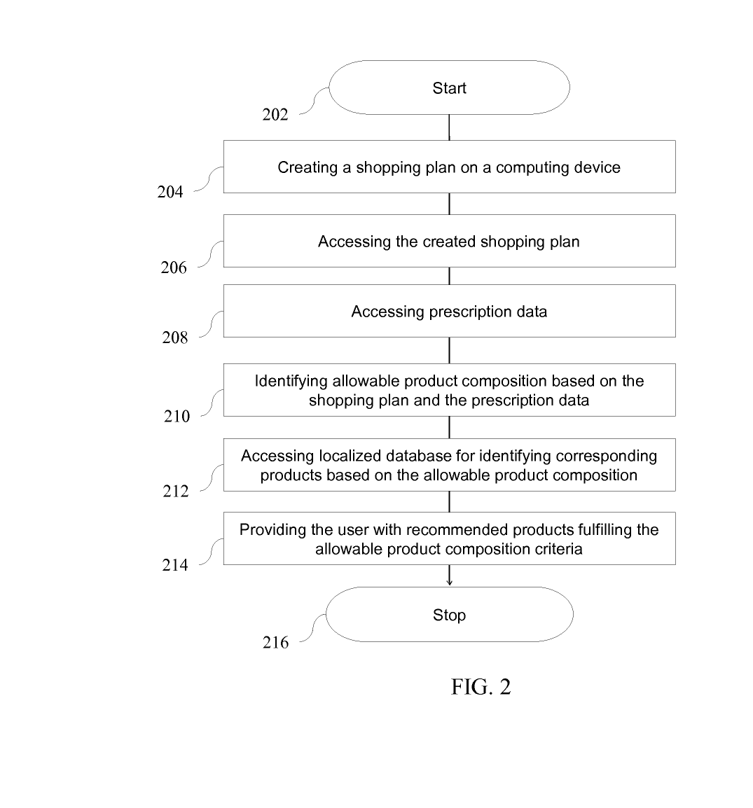

Moving on, FIG. 2 depicts a flow diagram depicting a method 200 of generating a personalized shopping recommendation, in accordance with an embodiment of the disclosure. For the purpose of this description, the method 200 is explained in conjunction with the shopping recommendation system 108 and its various components. However, it will be readily apparent to those ordinarily skilled in the art that the method 200 can also be applied, without deviating from the scope of the invention, for other similar systems. Moreover, the invention is not limited to the order in which the steps are listed in the method 200. In addition, the method 200 can contain a greater or fewer numbers of steps than those shown in FIG. 2.

The method 200 is initiated at step 202. Thereafter, at step 204, a shopping plan is created on a computing device, for example, the shopping plan 106 may be created on the computing device 102 by the user 104. In some embodiments, the shopping plan 106 created by the user 104 may include shopping plans for a person other than the user 104. In another exemplary embodiment, the user 104 may create a custom shopping plan 106 including items for more than one person.

Thereafter, at step 206, the shopping plan may be accessed, for example, the shopping plan 106 may be accessed by the first accessing module 110 under instructions from the processing module 116. In an embodiment, the shopping plan 106 may be stored in a memory of the computing device 104 and the first accessing module 110 may be operably coupled with the memory to access it as required.

Thereafter, at step 208, prescription data may be accessed, for example, prescription data 118 may be accessed by the second accessing module 112 under instructions from the processing module 116. In an embodiment, the second accessing module 112 may access one or more databases or data stores to search for and/or retrieve prescription data 118 corresponding to the user 104. In an embodiment, the prescription data 118 may be provided on a hospital server. In such a case, the computing device 102 can connect with the hospital network enabling the second accessing module 112 to get access to the prescription data 118. In a scenario where the shopping plan 106 may be for a person other than the user 104, the shopping recommendation system 108 may allow the user 106 to indicate the person for whom the shopping plan 106 has been created. In another scenario, when the user 104 creates a custom shopping plan 106 including items for more than one person then the shopping recommendation system 108 may allow the user 106 to indicate which items correspond to which person. In such exemplary embodiments, the processing module 116 can instruct the second accessing module 112 to access prescription data for the one or more persons indicated by the user 104. Further the processing module 116 will also compare the items on the shopping plan 106 with the prescription data according to the indication of which item corresponds to which person as given by the user 106.

Thereafter, at step 210, based on the shopping plan and the prescription data, allowable product compositions are identified. Subsequently, based on these allowable product compositions, corresponding products are identified from a localized database at step 212. For example, the third accessing module 114 may access one or more databases or data stores to search for and/or retrieve information regarding composition of various products. This information may be available in the localized database 120. For example, the localized database 120 may include details of all the ingredients present in a particular class of products from different manufacturers.

Thereafter, at step 214, the user is provided with recommended products fulfilling the allowable product composition criteria. For example, the processing module 116 may check components of products retrieved from the localized database 120 against information provided in the prescription data 118 and accordingly shortlist the recommended products.

Thereafter the method 200 is terminated at step 216.

In an embodiment, the method 200 may also include a step of calculating the quantity of the recommended products based on the prescription data 118. Furthermore, in some embodiments, the method 200 may include a step of sending a reminder for timely consumption of the recommended products. For example, in an exemplary scenario, the reminder may just be that a particular product should not be taken at same time as medicine or a particular product should not be consumed within 1 hour of taking a medicine.

In some embodiments, the method 200 may also include a step of displaying relevant advertisements based on the prescription data and the shopping plan, i.e. in addition to just providing recommended products, the user 104 may also be provided with advertisements for some relevant products.

In some embodiments, the method 200 may also provide a warning on a problematic product on the shopping plan 106 based on the prescription data 118. In some other embodiments, the method 200 may also include a step of generating an optimized route plan to locations corresponding to recommended products on the shopping plan 106. In an exemplary scenario, a map to a store where the recommended product may be available may be provided.

The disclosure also provides a computer program product that includes instructions that enables the execution of a method described herein, for example the method 200. For example, the method may be carried out using instructions of the computer program product executing on one or more suitably configured microprocessors or microcontrollers.

In an embodiment, the computer program product may incorporate various features of the present invention and be encoded on various computer readable storage media, suitable media include magnetic disk or tape, optical storage media such as compact disk or DVD (digital versatile disk), flash memory, and the like. Computer readable media encoded with the program code may be packaged with a compatible device or provided separately from other devices. Program code may also be encoded and transmitted using carrier signals (e.g. via Internet download) adapted for transmission via wired, optical, and/or wireless networks conforming to a variety of protocols, including the Internet.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method for generating a personalized shopping recommendation, the method comprising:
accessing a shopping plan, for one or more persons, created on a computing device of a user;
accessing corresponding prescription data advised for the one or more persons by a doctor; and
identifying a plurality of recommended products for the one or more persons based on the shopping plan and the prescription data.

2. The method according to claim 1, wherein the computing device is a mobile device.

3. The method according to claim 1, wherein accessing corresponding prescription data comprises accessing the prescription data electronically from a hospital network.

4. The method according to claim 1, wherein the plurality of recommended products comprise food products and non-food products.

5. The method according to claim 1, wherein quantity of the plurality of recommended products is calculated based on the prescription data.

6. The method according to claim 1, wherein identifying the plurality of recommended products comprises checking the components of products on the shopping plan against the prescription data.

7. The method according to claim 1 further comprising sending a reminder for timely consumption of the plurality of recommended products.

8. The method according to claim 1 further comprising displaying relevant advertisements on the computing device based on the prescription data and the shopping plan.

9. The method according to claim 1 further comprising providing a warning on a problematic product on the shopping plan based on the prescription data.

10. The method according to claim 1 further comprising providing an optimized route plan to locations corresponding to products on the shopping plan.

11. The method according to claim 1, wherein the user indicates which item corresponds to which person of the one or more persons.

12. A system for generating a personalized shopping recommendation, the system comprising:
a first accessing module configured to access a shopping plan, for one or more persons, created on a computing device of a user;
a second accessing module configured to access corresponding prescription data advised for the one or more persons by a doctor;
a processing module configured to identify a plurality of recommended products based on the shopping plan and the prescription data.

13. The system according to claim 12, wherein the computing device is a mobile device.

14. The system according to claim 12, wherein the second accessing module accesses the prescription data electronically from a hospital network.

15. The system according to claim 12, wherein the plurality of recommended products comprise food products and non-food products.

16. The system according to claim 12, wherein the processing module is further configured to calculate the quantity of the plurality of recommended products based on the prescription data.

17. The system according to claim 12, wherein the processing module is configured to identify the plurality of recommended products by checking the components of products on the shopping plan against the prescription data.

18. The system according to claim 12, wherein the processing module is further configured to send a reminder for timely consumption of the plurality of recommended products.

19. The system according to claim 12, wherein the processing module is further configured to display relevant advertisements on the computing device based on the prescription data and the shopping plan.

20. The system according to claim 12, wherein the processing module is further configured to provide a warning on a problematic product on the shopping plan based on the prescription data.

21. The system according to claim 12, wherein the processing module is further configured to generate an optimized route plan to locations corresponding to products on the shopping plan.

22. The system according to claim 12, wherein the user indicates which item corresponds to which person of the one or more persons.

23. A computer program product comprising computer readable medium, the computer readable medium comprising a program code used by a processor for execution on a computing device, with a purpose of generating personalized shopping recommendation, the computer program product comprising instructions for:
accessing a shopping plan, for one or more persons, created on a computing device of a user;
accessing corresponding prescription data advised for the one or more persons by a doctor; and
identifying a plurality of recommended products based on the shopping plan and the prescription data.

24. The computer program product according to claim 23, wherein the computing device is a mobile device.

25. The computer program product according to claim 23, wherein accessing corresponding prescription data comprises accessing the prescription data electronically from a hospital network.

26. The computer program product according to claim 23, wherein the plurality of recommended products comprise food products and non-food products.

27. The computer program product according to claim 23, wherein quantity of the plurality of recommended products is calculated based on the prescription data.

28. The computer program product according to claim 23, wherein identifying the plurality of recommended products comprises checking the components of products on the shopping plan against the prescription data.

29. The computer program product according to claim 23 further comprising instructions for sending a reminder for timely consumption of the plurality of recommended products.

30. The computer program product according to claim 23 further comprising instructions for displaying relevant advertisements on the computing device based on the prescription data and the shopping plan.

31. The computer program product according to claim 23 further comprising instructions for providing a warning on a problematic product on the shopping plan based on the prescription data.

32. The computer program product according to claim 23 further comprising instructions for providing an optimized route plan to locations corresponding to products on the shopping plan.

33. The computer program product according to claim 23 further comprising instructions for enabling the user to indicate which item corresponds to which person of the one or more persons.
